(19) United States
(12) Patent Application Publication
(10) Pub. No.: US 2016/0318381 A1
(43) Pub. Date: Nov. 3, 2016

(54) SHADING ASSEMBLY

(71) Applicant: Inalfa Roof Syetems Group B.V., Oostrum (NL)

(72) Inventor: Theodorus Wilhelmus Camps, Tegelen (NL)

(21) Appl. No.: 15/142,760

(22) Filed: Apr. 29, 2016

Related U.S. Application Data
(63) Continuation-in-part of application No. 14/221,539, filed on Mar. 21, 2014, now abandoned.

(30) Foreign Application Priority Data
Mar. 26, 2013 (EP) 13161076.8

(51) Int. Cl. B60J 7/08

(52) U.S. Cl. CPC B60J 7/085

(57) ABSTRACT

A rollo assembly is provided, comprising a winding shaft defining an axis of rotation and a flexible rollo screen of which a first end is attached to the winding shaft, such that the rollo screen by an appropriate rotation of the winding shaft around its axis of rotation may be wound on or off the winding shaft. Part of the rollo screen wound off from the winding shaft extends along a certain path. The winding shaft is movable in a direction perpendicularly to its axis of rotation in such a manner that the part of the rollo screen wound off from the winding shaft always extends substantially along the same path independently from the amount of rollo screen wound off from the winding shaft.

### BACKGROUND

The discussion below is merely provided for general background information and is not intended to be used as an aid in determining the scope of the claimed subject matter.

Aspects of the invention relate to a rollo assembly, comprising a winding shaft defining an axis of rotation and a flexible rollo screen of which a first end is attached to the winding shaft, such that the rollo screen by an appropriate rotation of the winding shaft around its axis of rotation may be wound on or off the winding shaft and wherein the part of the rollo screen wound off from the winding shaft extends along a certain path.

The path along which the part of the rollo screen wound off from the winding shaft extends depends from the amount of rollo screen wound off from the winding shaft. Such a path extends tangentially starting from a circumferential position of the winding shaft which moves closer to the axis of rotation of the winding shaft with an increase of the amount of rollo screen wound off from the winding shaft, leading to a corresponding shift of said path.

Such a shift, however, of the path along which the rollo screen extends causes problems in some applications of the rollo assembly. For example, when the rollo assembly is applied to a vehicle for cooperation with an open roof construction, such a shift would lead to a varying distance between the wound off part of the rollo screen and a stationary headliner (or a side finisher thereof). To avoid such a varying distance, it is known to use a transverse guide extending at some distance from the winding shaft across the rollo screen (generally in parallel to the winding shaft). The position of this guide is such, that the part of the rollo screen wound off from the winding shaft always will engage said guide irrespective the amount of rollo screen wound off from the winding shaft. As a result the section of the path of the rollo screen starting at the guide and extending in a direction away from the winding shaft always will have the same position.

Although such a guide provides a solution for the above mentioned problems, it may lead to another problem. When using specific materials for the rollo screen, the guide may cause markings on the rollo screen. Especially when the rollo screen remains in a wound on position for a long time, the pressure of the guide applied to the rollo screen may cause markings which initially may be invisible, for example when the guide is hidden behind another part such as a headliner of a vehicle, but which become visible when the rollo screen is wound off from the winding shaft.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

A rollo assembly is provided in which the winding shaft is movable in a direction perpendicularly to its axis of rotation in such a manner that the part of the rollo screen wound off from the winding shaft always extends substantially along the same path independently from the amount of rollo screen wound off from the winding shaft.

Aspects of the invention are based on the idea that the shift of the circumferential position of the winding shaft (starting from which the path of the rollo screen extends) towards (or away from) the axis of rotation of the winding shaft (as caused by winding off or on, respectively, the rollo screen) may be compensated by a corresponding shift of the winding shaft (thus its axis of rotation).

In one embodiment of the rollo assembly according to the present invention the direction in which the winding shaft is movable, extends substantially perpendicularly to the direction of the path along which the part of the rollo screen wound off from the winding shaft extends. Generally this means that the overall location of said circumferential position of the winding shaft is maintained. The indication “overall location” intends to express a location relative to a surrounding construction which itself may be movable or not (for example a vehicle).

It is noted however, that the movement of the winding shaft also may occur in a different direction (not perpendicularly to the direction of said path), such that, although said circumferential position of the winding shaft again is maintained in the plane of said path, it experiences a shift in said plane (or in other words, the part of the rollo screen wound off from the winding shaft is maintained at the same level but said circumferential position will shift in said level).

Further it should be noted that the indication “direction of the path” does not necessarily mean that said path extends in a straight manner. It is also possible that such a path is (partly) curved and in such a situation said direction may be defined as an average direction.

In another embodiment the rollo assembly comprises stationary pressure means engaging the rollo screen substantially at the position where it starts to be wound off from the winding shaft, wherein the winding shaft is spring loaded towards said stationary pressure means.

Such stationary pressure means assure that said position (corresponding to the circumferential position of the winding shaft referred to previously) is maintained at the same level as explained above.

It is noted that “stationary pressure means” tries to express that the location where said pressure means engage the rollo screen is kept at a stationary position, although the pressure means may be movable in some manner (as will be explained below with respect to a specific embodiment).

When said stationary pressure means are located near to the opposite transverse edges of the rollo screen, it may be avoided effectively that said pressure means cause markings on the part of the rollo screen which are visible for a user (generally the transverse edges of the rollo screen will be guided in lateral guides such that any markings near said transverse edges will be hidden from sight by such lateral guides).

It is possible that the stationary pressure means are rollers rotatable around stationary axes. But also the use of other pressure means is conceivable, such as slide shoes made of a low friction material. The choice will depend, among others, from the material of the rollo screen.

In one embodiment of the rollo assembly the winding shaft is spring loaded by spring members engaging opposite outer ends of the winding shaft. Such spring members may come in many varieties, such as compression springs or tension springs.

The winding shaft, for defining the direction in which it is movable, may comprise two opposite outer ends cooperating with stationary guides. Such guides may extend in a straight line, but it also is possible that these guides extend in a curved manner.

As an alternative to such guides, it is possible that the winding shaft, for defining the direction in which it is movable, comprises two opposite outer ends mounted on two pivot arms. As a result the winding shaft will move along part of a circle. This, however, will not cause problems because the total distance over which the winding shaft will move, will be relatively small (generally not more than a few centimetres).

In another embodiment of the rollo assembly the winding shaft at at least one of its ends is provided with a spiral shaped guide slot and wherein the rollo assembly further comprises a stationary guide pin engaging said guide slot, wherein the shape of the spiral shaped guide slot substantially corresponds with the shape of the part of the rollo screen wound on the winding shaft and wherein the winding shaft comprises two opposite outer ends cooperating with stationary guides.

During rotation of the winding shaft the stationary guide pin will travel in the spiral shaped guide and thus will cause the (outer ends of the) winding shaft to move in the stationary guides.

In yet another embodiment the rollo assembly comprises a driving member for moving the winding shaft in said direction perpendicularly to its axis of rotation, a sensor means for generating a signal representative for the amount of rollo screen wound off from the winding shaft and control means for receiving said signal and for, based upon said signal, controlling the driving member.

For example the driving member may comprise at least one linear actuator, and preferably two linear actuators engaging opposite outer ends of the winding shaft.

In another embodiment the sensor means may be adapted for sensing the rotation of the winding shaft around the axis of rotation.

The rollo assembly may be used both in case the winding shaft, and its axis of rotation, extend along a straight or curved line; further its use may extend both to rollo screens which are operated manually or by a driving device, such as an electric motor. The winding shaft may be spring loaded for winding thereon the rollo screen.

### BRIEF DESCRIPTION OF THE DRAWINGS

Hereinafter aspects of the invention will be elucidated while referring to the drawing, in which:

FIGS. 1a-1d illustrate a state of the art rollo assembly in two different positions, both in a perspective view and in a side elevational view;

FIGS. 2a-2f illustrate a first embodiment of the rollo assembly in two different positions, both in a perspective view and in a side elevational view;

FIGS. 3a-3f illustrate a second embodiment of the rollo assembly in two different positions, both in a perspective view and in a side elevational view;

FIGS. 4a-4b illustrate a third embodiment of the rollo assembly in two different positions in a side elevational view, and

FIGS. 5a-5b schematically illustrate a fourth embodiment of the rollo assembly in two different positions in a side elevational view;

FIG. 6 schematically illustrates a further embodiment of the rollo assembly in two different positions in a side elevational view;

FIG. 7 schematically in a side elevational view illustrates two different positions of a roller relative to a winding shaft; and

FIG. 8 schematically illustrates a further embodiment of the rollo assembly in two different positions in a side elevational view.

### DETAILED DESCRIPTION OF THE ILLUSTRATIVE EMBODIMENTS

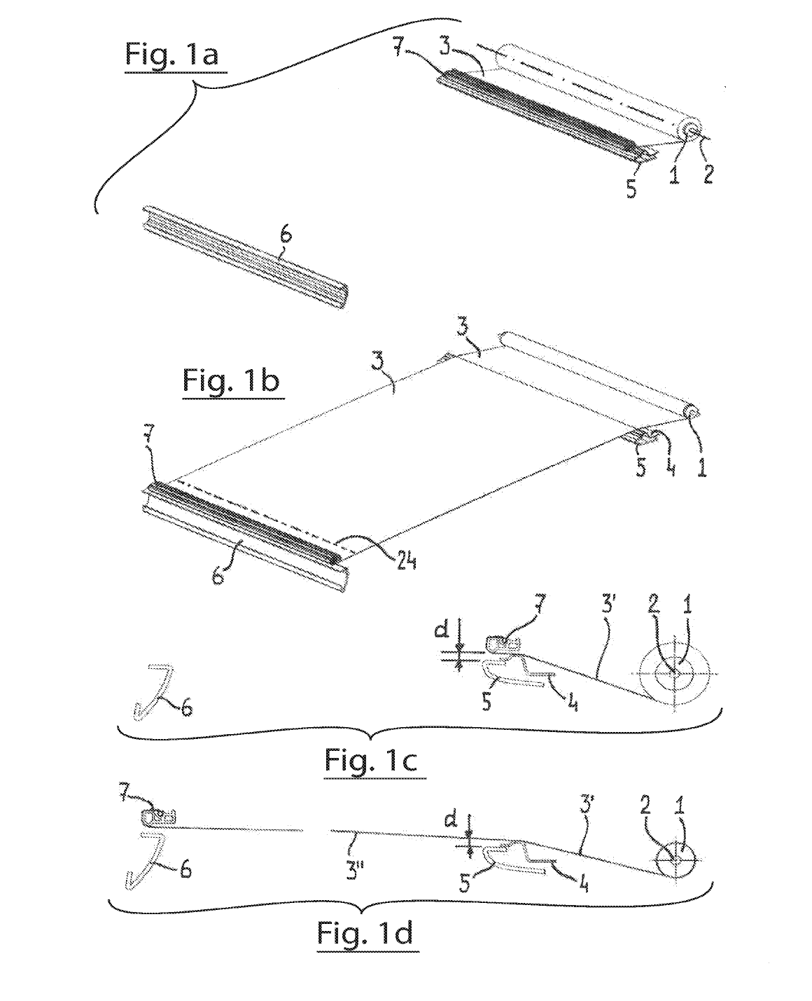

Firstly referring to FIGS. 1a-1c, a state of the art rollo assembly or shading assembly comprises a winding shaft 1 defining an axis of rotation 2 and a flexible rollo screen 3 of which a first end is attached to the winding shaft, such that the rollo screen by an appropriate rotation of the winding shaft around its axis of rotation may be wound on or off the winding shaft. The part of the rollo screen 3 wound off from the winding shaft 2 extends along a certain path which in FIGS. 1c and 1d best may be seen as defined by the parts 3′ and 3″ of the rollo screen 3 wound off from the winding shaft 1.

For assuring that the part of the path corresponding with rollo screen part 3″ will maintain its position, the state of the art uses a stationary transverse guide 4 supporting the rollo screen 3. As a result the rollo screen part 3″ always will have the same distance d with respect to (a side finisher of) a headliner 5 (which may be part of a vehicle, for example, of which further another part 6 of the headliner is illustrated), for example in a position in which the rollo screen 3 is wound maximally onto the winding shaft 1 (FIGS. 1a and 1c) and a position in which the rollo screen 3 is wound off maximally from the winding shaft 1 (FIGS. 1b and 1d).

Such a transverse guide 4, however, may cause markings on the rollo screen 3, for example in the situation shown in FIG. 1a, which markings 24 become visible in a situation as illustrated in FIG. 1b.

Finally FIG. 1a shows a pull beam 7 attached to a free edge of the rollo screen 3, as is known per se.

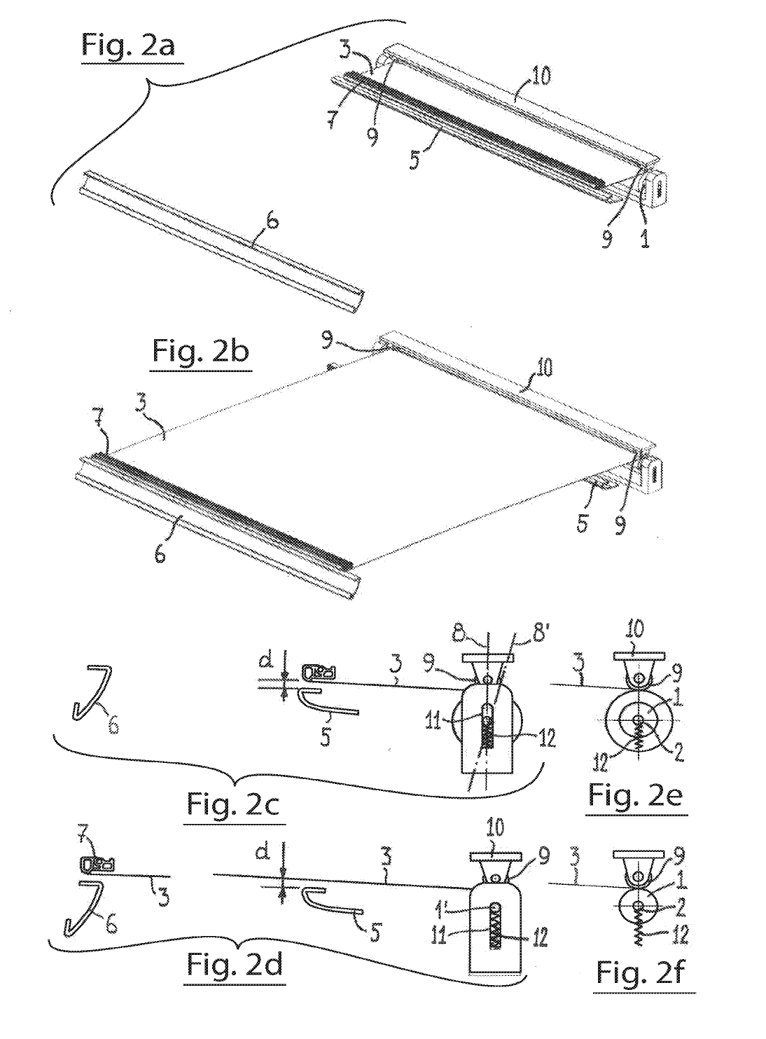

In FIGS. 2a-2b a first embodiment of a rollo assembly according to aspects of the invention is illustrated in positions corresponding with FIG. 1a-1b. As will be explained below, the winding shaft (best visible in right parts of FIGS. 2c and 2d, FIGS. 2e and 2f, respectively in which a guide to be described later has not been shown) is movable in a direction perpendicularly to its axis of rotation 2 in such a manner that the part of the rollo screen 3 wound off from the winding shaft 1 always extends substantially along the same path independently from the amount of rollo screen wound off from the winding shaft.

The direction in which the winding shaft 1 is movable (in FIG. 2c indicated by line 8), may extends substantially perpendicularly to the direction of the path along which the part of the rollo screen 3 wound off from the winding shaft 1 extends (represented by rollo screen part 3 in FIG. 2c), but also may extend at a different angle with respect thereto (indicated schematically in FIG. 2c by a different orientation of line 8′).

The rollo assembly can comprise a stationary applying assembly. In one embodiment portions of the stationary applying assembly comprises two rollers 9 mounted for a rotation around stationary axes in brackets 10 and engaging the rollo screen 3 substantially at the position where the rollo screen 3 starts to be wound off from the winding shaft 1. Said rollers 9 are located near to the opposite transverse edges of the rollo screen 3 and in the present embodiment the brackets 10 are combined into a single part.

The winding shaft 1, for defining the direction in which it is movable, comprises two opposite outer ends 1′ (indicated in FIG. 2d only) cooperating with stationary guides 11 for clarity and simplification of illustration, only one stationary guide 11 can be seen in the perspective and side views of FIGS. 2a-2d. However, a second stationary guide 11 is included for the end of the winding shaft opposite the illustrated stationary guide 11. Further the winding shaft 1 is spring loaded by spring members 12 engaging said opposite outer ends 1′ of the winding shaft 1 for a movement towards the rollers 9.

When comparing FIGS. 2c and 2d it becomes clear that during unwinding the rollo screen 3 from the winding shaft 1, the winding shaft moves 1 along the guides 11 such that the distance between its axis of rotation 2 and the position where the rollo screen 3 starts to be wound off from the winding shaft 1 (here substantially the position where the rollers 9 engage the rollo screen) decreases. As a result the distance d (FIGS. 2c and 2d) between the rollo screen 3 and a stationary part (headliner) 5 is kept constant without the use of a separate guide.

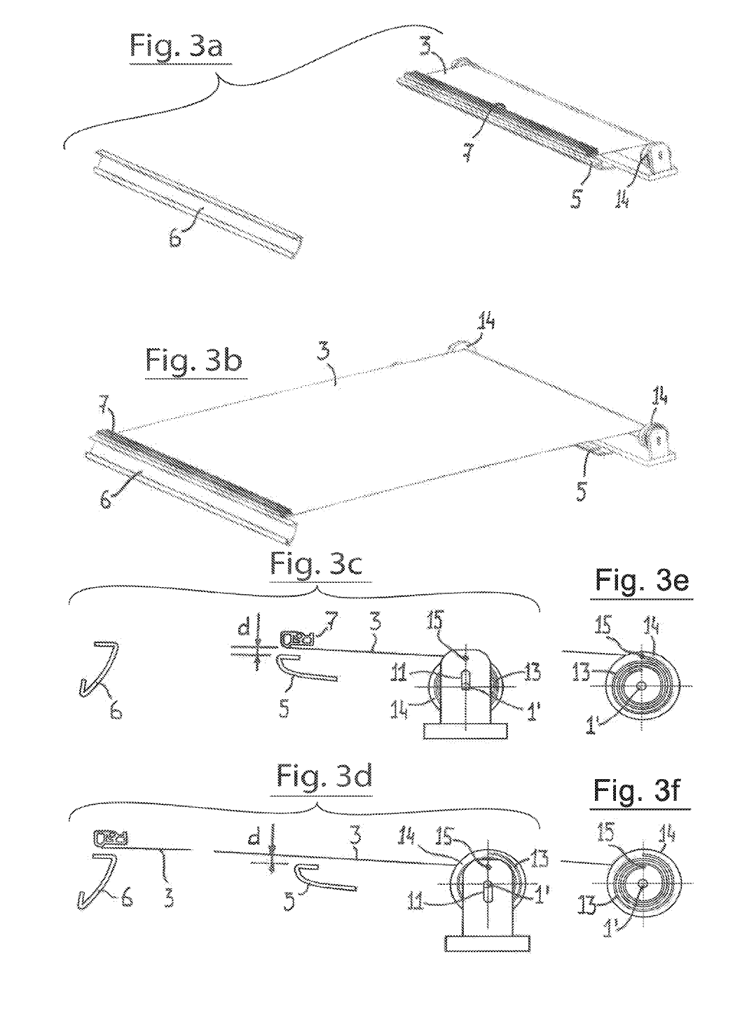

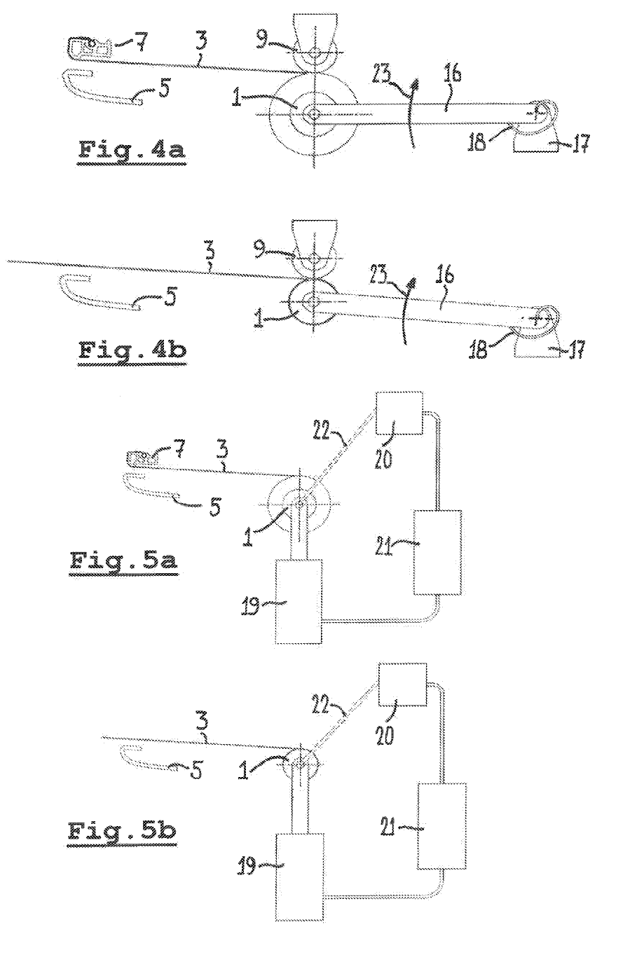

In FIGS. 3a-3b an embodiment of the rollo assembly is illustrated in which the winding shaft 1 at its opposite ends is provided with a spiral shaped guide slot 13 defined in a disc member 14 attached to the winding shaft 1 for a rotation therewith. The rollo assembly further comprises a stationary guide pin 15 (illustrated schematically in FIGS. 3c-3f; in reality this guide pin 15 will not be visible in these views) engaging said guide slot 13. The shape of the spiral shaped guide slot 13 will substantially correspond with the shape of the part of the rollo screen 3 wound on the winding shaft 1. The winding shaft 1, as before, comprises two opposite outer ends 1′ cooperating with stationary guides 11.

When the winding shaft 1 rotates, the guide pin 15 (which generally will be attached to a member in which guide 11 is defined) travels in the spiral shaped guide slot 13 and causes a movement of the winding shaft 1 (its ends 1′) along the guides 11. As a result the distance d (FIGS. 3c and 3d) between the rollo screen 3 and a stationary part (headliner) 5 is kept constant without the use of a separate guide.

In FIGS. 4a-4b an embodiment of the rollo assembly is illustrated in which the winding shaft 1, for defining the direction in which it is movable, comprises two opposite outer ends mounted on two pivot arms 16 mounted for a rotation to stationary mounts 17. These pivot arms 16 are spring loaded by a spring 18 for moving the winding shaft towards rollers 9 (according to arrow 23).

FIGS. 5a-5b schematically shows an embodiment of the rollo assembly in which a driving member 19 for moving the winding shaft 1 in said direction perpendicularly to its axis of rotation is provided. A sensor 20 is configured to generate a signal representative for the amount of rollo screen wound off from the winding shaft 1 is connected with a controller 21 configured to receive said signal and for, based upon said signal, controlling the driving member 19. The driving member 19 may comprise at least one linear actuator, and preferably two linear actuators engaging opposite outer ends of the winding shaft 1 (for example driving screws engageable by driving nuts attached to said outer ends of the driving shaft 1). However, alternative driving members are conceivable too, for example pivot arms 16 as illustrated in FIGS. 4a-4b (then the rollers 9 would not be used, but the rotation of the pivot arms 16 would be controlled).

The sensor 20, for example, may be configured to sense the rotation of the winding shaft 1 around the axis of rotation (as illustrated schematically by sensing line 22).

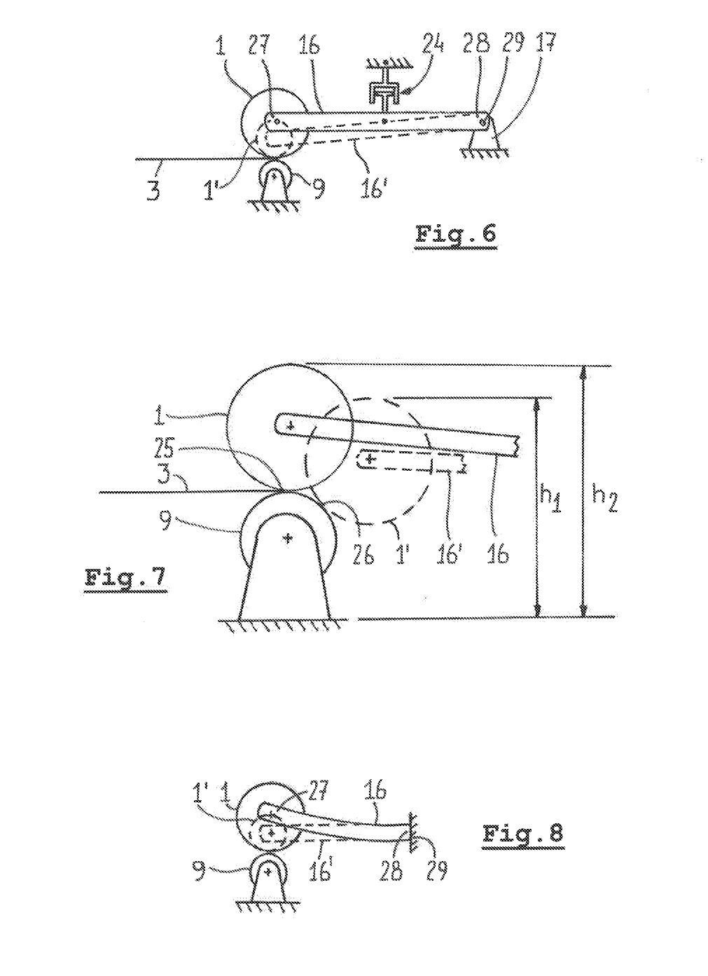

In FIG. 6 an embodiment of the rollo assembly is illustrated in which the winding shaft 1 with its outer ends is mounted on a pair of pivot arms 16 (one of which is illustrated, the other pivot arm being mounted to an end of the winding shaft 1 opposite the pivot arm 16 illustrated). In this embodiment, the pivot arms 16 are gravity loaded such that the winding shaft 1 is maintained in engagement with the roller(s) 9. This applies both for a situation (illustrated in full lines) in which much of the rollo screen 3 is still wound onto the winding shaft (winding shaft 1, pivot arms 16) and a situation (illustrated in broken lines) in which less of the rollo screen 3 is still wound onto the winding shaft (winding shaft 1′, pivot arms 16′). Further this figure illustrates a damper 24 for damping the pivotal movement of the pivot arms 16 for avoiding any detrimental oscillations.

In FIG. 7 two embodiments with different positions of the roller(s) 9 with respect to the winding shaft 1 (which again is mounted to pivot arms 16, 16′, shown in two embodiments) are illustrated. In a first embodiment (winding shaft 1) one can see that the at least one roller 9 engages the winding shaft 1′ at a circumferential position 25 which corresponds with the circumferential position where the rollo screen 3, in accordance with said certain path, in a tangential direction starts to be wound off from the winding shaft 1. In a second embodiment however (winding shaft 1′) the at least one roller 9 engages the winding shaft 1′ at such a circumferential position 26 that the rollo screen 3 after said position first extends partly around the roller (in the illustrated embodiment substantially between positions 26 and 25) before extending along said certain path. This allows to reduce the overall height of the structure (compare h1 and h2).

It is noted that in the embodiments illustrated in FIGS. 4a,4b,6-8 the pivot arms 16 have first ends (such as 27 in FIG. 6) to which the outer ends of the winding shaft 1 are mounted and opposite second ends (such as 28 in FIG. 6) mounted to stationary pivot axes (such as 29 in FIG. 6) for a pivotal movement around said pivot axes that is commonly substantially vertical movement of the winding shaft 1 (ignoring slight articulate movement of the second ends 28 and the winding shaft 1 due to the stationary pivot axes of the pivot arms 16). As an alternative, however, and as illustrated in FIG. 8, the pivot arms 16 also may have first ends 27 to which the outer ends of the winding shaft 1 are mounted and opposite second ends 28 which are rigidly attached to a stationary member 29 and wherein the pivot arms 16 are resiliently flexible (for assuming different positions such as 16 and 16′ when the diameter of the winding shaft 1 varies, such as between 1 and 1′, for keeping the winding shaft 1 engaged with the roller 9). In such an embodiment a separate spring may be dispensed with.

Although the subject matter has been described in language specific to structural features and/or methodological acts, it is to be understood that the subject matter defined in the appended claims is not necessarily limited to the specific features or acts described above as has been held by the courts. Rather, the specific features and acts described above are disclosed as example forms of implementing the claims.

What is claimed is:

1. A rollo assembly for an open roof construction of a vehicle, comprising:
a winding shaft defining an axis of rotation;
a stationarily positioned pressure applying assembly; and
a flexible rollo screen of which a first end is attached to the winding shaft, such that the rollo screen, by rotation of the winding shaft around the axis of rotation is wound on or off the winding shaft, wherein parts of the rollo screen wound off from the winding shaft extend along a certain path, wherein the winding shaft comprises two opposite outer ends mounted on two pivot arms which are loaded for a pivotal movement in a direction for moving the winding shaft in a direction substantially perpendicular to the axis of rotation towards and into engagement with the stationarily positioned pressure applying assembly in such a manner that parts of the rollo screen wound off from the winding shaft extend substantially along the certain path independently from an amount of rollo screen wound off from the winding shaft.

2. The rollo assembly according to claim 1, wherein said pressure applying assembly comprises at least one roller rotatable around a stationary axis.

3. The rollo assembly according to claim 2, wherein said pressure applying assembly comprises two rollers located near to the opposite outer ends of the winding shaft configured to engage only opposite longitudinally extending side edges regions of the rollo screen.

4. The rollo assembly according to claim 1, wherein the pivot arms are spring loaded.

5. The rollo assembly according to claim 1, wherein the pivot arms are gravity loaded.

6. The rollo assembly according to claim 1, wherein the pivot arms are provided with a damper configured to damp pivotal movement of the pivot arms.

7. The rollo assembly according to claim 1, wherein the pivot arms have first ends to which the outer ends of the winding shaft are mounted and opposite second ends mounted to stationary pivot axes for a pivotal movement around said pivot axes.

8. The rollo assembly according to claim 2, wherein the at least one roller engages the winding shaft at a circumferential position which corresponds with the circumferential position where the rollo screen, in accordance with said certain path, in a tangential direction starts to be wound off from the winding shaft.

9. The rollo assembly according to claim 2, wherein the at least one roller engages the winding shaft at such a circumferential position that the rollo screen after said position first extends partly around the roller before extending along said certain path.

10. The rollo assembly according to claim 1, wherein the pivot arms have first ends to which the outer ends of the winding shaft are mounted and opposite second ends rigidly attached to a stationary member and wherein the pivot arms are resiliently flexible.

11. The rollo assembly according to claim 3, wherein the at least one roller engages the winding shaft at a circumferential position which corresponds with the circumferential position where the rollo screen, in accordance with said certain path, in a tangential direction starts to be wound off from the winding shaft.

12. The rollo assembly according to claim 3, wherein the at least one roller engages the winding shaft at such a circumferential position that the rollo screen after said position first extends partly around the roller before extending along said certain path.
